(19) United States
(12) Patent Application Publication
(10) Pub. No.: US 2013/0291067 A1
(43) Pub. Date: Oct. 31, 2013

(54) Identification of Unauthorized or Misconfigured Wireless Access Point Using Distributed Endpoints

(71) Applicants: Terry Dwain Escamilla, Lafayette, CO (US); Charles Steven Lingafelt, Durham, NC (US); David Robert Safford, Brewster, NY (US)

(72) Inventors: Terry Dwain Escamilla, Lafayette, CO (US); Charles Steven Lingafelt, Durham, NC (US); David Robert Safford, Brewster, NY (US)

(73) Assignee: INTERNATIONAL BUSINESS MACHINES CORPORATION, Armonk, NY (US)

(21) Appl. No.: 13/459,383

(22) Filed: Apr. 30, 2012

Related U.S. Application Data
(63) Continuation of application No. 13/455,419, filed on Apr. 25, 2012.

(51) Int. Cl. G06F 21/00; H04W 12/00

(52) U.S. Cl. 726/4

(57) ABSTRACT

A method for identifying unauthorized and/or misconfigured wireless access points (WAPs) in a communication network includes the steps of: an agent running on an endpoint in the communication network locating one or more WAPs in the communication network; the agent reporting at least one located WAP to a central entity; and the central entity performing steps of applying prescribed criteria to determine whether the located WAP needs to be probed, and initiating active probing of the located WAP when it is determined that the located WAP needs to be probed to thereby determine whether the located WAP is unauthorized and/or misconfigured.

### CROSS-REFERENCE TO RELATED APPLICATION(S)

The present application is a continuation of U.S. patent application Ser. No. 13/455,419, filed Apr. 25, 2012, the entire contents of which are expressly incorporated herein by reference in its entirety for all purposes.

### FIELD OF THE INVENTION

The present invention relates generally to the electrical, electronic, and computer arts, and more particularly relates to secure wireless communications.

### BACKGROUND

Wireless networking has become a pervasive communication vehicle. Enterprises of all sizes are establishing wireless networks (e.g., using an IEEE 802.11 protocol standard, or the like) for numerous reasons, including, but not limited to, reducing wiring costs, providing connectivity throughout large office or warehouse space, employee convenience, courtesy access for guests, providing remote access to data, etc. With an increasing reliance on wireless communication systems as a means of conveying critical business information, however, weaknesses in such systems are often exploited to gain access to important business information and systems.

Security challenges relating to wireless local area networks (WLANs), such as, for example, communications using an IEEE 802.11 wireless communication protocol (Wi-Fi), are well understood. In particular, the issue of “open” wireless access points (WAPs), which have not been properly configured to control access (e.g., rogue access points), have led to widespread attention, including wardriving, which involves the act of searching for Wi-Fi wireless networks by a person in a moving vehicle, and warchalking, which involves drawing symbols in public places to advertise an open Wi-Fi wireless network. In response, numerous wireless security systems which detect and identify open or misconfigured WAPs have been developed, including, for example IBM Corporation's wireless security auditor (WSA) and distributed wireless security auditor (DWSA), Kismet products, Airmagnet, Cisco Wireless Control System (WCS), among others. Despite modern efforts to control access through WAPs, however, there remain significant problems with the conventional approaches.

### SUMMARY

Advantageously, aspects of the present invention provide a mechanism for identifying unauthorized or misconfigured wireless access points (WAPs) in a communication network (e.g., a corporate intranet) including multiple endpoints. To accomplish this, illustrative embodiments of the invention beneficially place an agent on multiple endpoints and then, based on information received from the endpoints and on an application of prescribed criteria (e.g., business rules), cause at least a subset of the endpoints to perform certain actions, such as, for example, active probing, which thereby generate information sufficient to identify misconfigured and/or inappropriate WAPs in the network.

In accordance with one embodiment of the invention, a system for identifying unauthorized and/or misconfigured wireless access points (WAPs) in a communication network includes a plurality of network endpoints and a plurality of agents running on the plurality of endpoints. The agents are adapted to periodically locate WAPs and to report located WAPs to a central entity. The system further includes a central entity operative to receive information from the agents regarding located WAPs, to determine whether at least a given one of the located WAPs needs to be probed, and to initiate active probing of located WAPs when it is determined that the given one of the located WAPs needs to be probed.

In accordance with another embodiment of the invention, a method for identifying unauthorized and/or misconfigured WAPs in a communication network includes the steps of: an agent running on an endpoint in the communication network locating one or more WAPs in the communication network; the agent reporting at least one located WAP to a central entity; and the central entity performing steps of applying prescribed business rules to determine whether the at least one located WAP needs to be probed, and initiating active probing of the at least one located WAP when it is determined that the at least one located WAP needs to be probed to determine whether the located WAP is at least one of unauthorized and misconfigured.

In accordance with yet another embodiment of the invention, an apparatus for identifying unauthorized and/or misconfigured WAPs in a communication network includes at least one processor. The processor is operative: (i) to initiate an agent to run on at least one endpoint in the communication network, the agent being adapted for locating one or more WAPs in the communication network; (ii) to receive from the agent information relating to at least one located WAP; (iii) to apply prescribed criteria for determining whether the located WAP needs to be probed; and (iv) to initiate active probing of the located WAP when it is determined that the located WAP needs to be probed to thereby determine whether the located WAP is unauthorized and/or misconfigured.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, embodiments of the invention may provide one or more of the following advantages, among others:
reducing the likelihood of a communication network being compromised by unauthorized users, thereby reducing the likelihood of data loss, data corruption or compromise;
reducing the likelihood of virus and/or malware injection into the client infrastructure;
ensuring compliance of WAPs to client or regulatory security configuration standards;
protecting employees of a corporate intranet from connecting to unauthorized or rogue WAPs trying to impersonate a valid client WAP.

Thus, by employing techniques according to aspects of the invention, unauthorized or misconfigured WAPs can be advantageously detected without the need for maintaining a database of “approved” access points which requires continual updating.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram depicting at least a portion of an exemplary system 100, according to an embodiment of the invention;

FIG. 2 is a flow diagram depicting at least a portion of an exemplary method for identifying unauthorized or misconfigured WAPs in a system (e.g., communication network), according to an embodiment of the invention; and

FIG. 3 is a block diagram depicting at least a portion of an exemplary system operative to run software according to embodiments of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Aspects of the present invention will be described herein in the context of illustrative apparatus and methods for identifying unauthorized or misconfigured wireless access points (WAPs) in a communication network (e.g., a corporate intranet) including multiple endpoints. To accomplish this, illustrative embodiments of the invention beneficially place an agent on multiple endpoints and then, based on information received from the endpoints and on an application of prescribed criteria (e.g., business rules), cause at least a subset of the endpoints to perform certain actions, such as, for example, active probing, which thereby generate information sufficient to identify misconfigured and/or inappropriate WAPs in the network. Thus, techniques in accordance with illustrative embodiments of the invention beneficially perform monitoring and probing of WAPs to thereby identify unauthorized or misconfigured WAPs.

It is to be appreciated, however, that the invention is not limited to the specific apparatus and/or methods illustratively shown and described herein. Rather, embodiments of the invention are directed broadly to techniques for identifying unauthorized or misconfigured WAPs in a communication network in a manner which does not interfere with normal or wireless network operations of the client. Moreover, it will become apparent to those skilled in the art given the teachings herein that numerous modifications can be made to the embodiments shown that are within the scope of the present invention. That is, no limitations with respect to the specific embodiments described herein are intended or should be inferred.

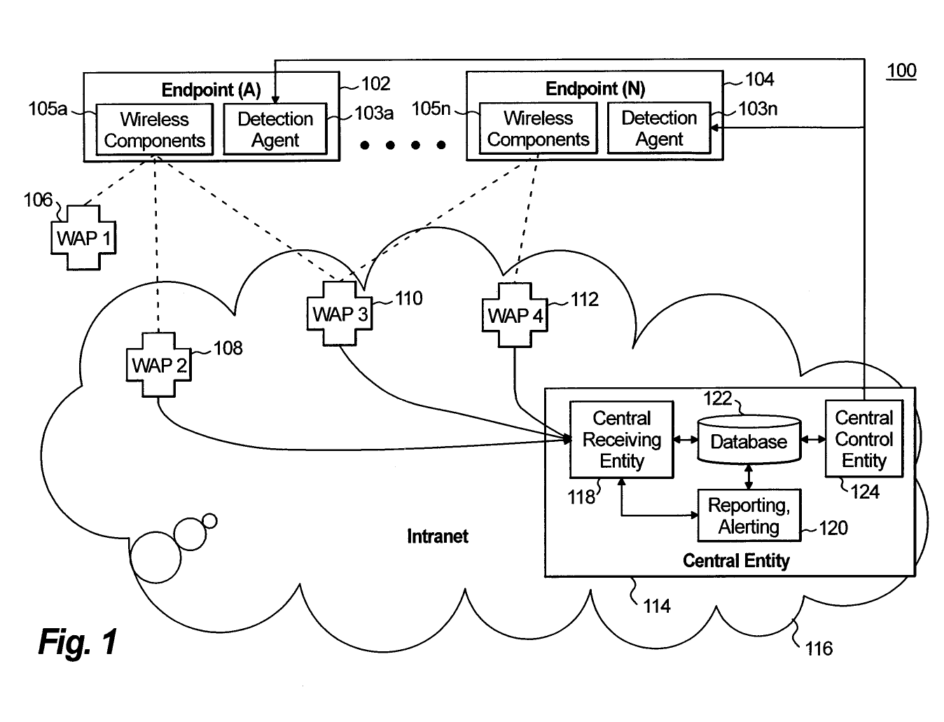

FIG. 1 is a block diagram depicting at least a portion of an exemplary system 100, according to an embodiment of the invention. The system 100 includes a plurality of endpoints, endpoint (A) 102 through endpoint (N) 104, a plurality of wireless access points, WAP 1 106, WAP 2 108, WAP 3 110 and WAP 4 112, and a central entity 114. A communication path between the central entity 114 and the respective endpoints 102 through 104 is typically within an intranet 116, or an alternative communication means. At least a portion of the WAPs (e.g., WAPs 108, 110 and 112) reside within the intranet 116, while one or more WAPs (e.g., WAP 106) may reside outside the intranet. Intranet 116 is preferably representative of a corporate intranet, for example.

Each of at least a subset of the endpoints 102 through 104 includes a detection agent or module 103a through 103n, respectively, and wireless components 105a through 105n, respectively. Each of the wireless components 105a through 105n may include a wireless transceiver or an alternative wireless interface (e.g., wireless network access card) for communicating with corresponding WAPs in the system 100. For example, wireless components 105a communicates with WAPs 106, 108 and 110, and wireless components 105n communicates with WAPs 110 and 112.

The central entity 114 comprises a central receiving entity or module 118, a reporting and alerting entity or module 120 coupled with the central receiving entity 118, a database 122 or alternative storage element coupled with the central receiving entity 118 and the reporting and alerting module 120, and a central control entity or module 124 coupled with the database 122. The central entity 114 collects and analyzes the passive (e.g., “locate” operation) and active (e.g., “probe” operation) data, and controls the endpoint agents based on the results thereof. More particularly, the central entity 114 is essentially a server (or collection of servers) operative, through the central receiving entity 118, the reporting and alerting module 120, the database 122, and/or the central control entity 124, to control the endpoint detection agents 103a through 103n (e.g., via the central control entity 124), to store prescribed information (e.g., business rules, etc.) in the database 122, to receive messages that traverse through a given WAP under observation and across the intranet 116 (e.g., via the central receiving entity 118), and to report (i.e., alert) a prescribed condition as a function of the received message(s) (e.g., via the reporting and alerting module 120). The data stored in database 122 may comprise, for example, all of the endpoint agent reports (e.g., name and address of located WAPs), and probe packets received. This data is used to determine whether a given WAP is misconfigured or unauthorized, but these results are not necessarily stored in the database itself.

It is to be appreciated that the term “located” as used, for example, in conjunction with WAPs (e.g., a located WAP) is intended to broadly refer to a WAP that is detected, discovered, or identified, rather than to a physical position/location of the WAP. Likewise, the term “locating” as used in conjunction with WAPs (e.g., locating a WAP) is intended to broadly refer to the act of detecting, discovering, or identifying a WAP, rather than to the act of determining a physical position/location of the WAP. In many instances, for example, a WAP is “located” virtually (i.e., as an abstraction) in terms of its network address or alternative identifier. Thus, the terms “located” or “locating” as used herein are intended to broadly encompass a virtual or physical location of an entity to which the terms refer.

The detection agent or module 103a through 103n running on the endpoints 102 through 104, respectively, may be configured to locate one or more corresponding WAPs in the communication network during prescribed time intervals, such as, for example, when performing a discovery operation. In some embodiments, the prescribed time intervals during which the agents are operative to locate one or more WAPs are periodic.

In accordance with an illustrative embodiment, under control of the central control entity 124, the endpoints 102 through 104 are operative to periodically monitor (i.e., “listen” for) the WAPs 106, 108, 110, 112. With regard to WAP 106, which is outside of the intranet 116 in this illustration, the detection agent 103a running on endpoint 102 will locate WAP 106, and based on prescribed policies, the central entity 114 may direct that agent to actively probe this WAP. Since the WAP 106 is not connected to the intranet 116, the probe will not be delivered to the central receiving entity 118, thereby providing evidence that this WAP is not connected to the intranet.

A report of an observed WAP is sent to the central control entity 124, which may receive more than one report, with multiple reports (from different endpoints) identifying the same WAP. The central control entity 124 then applies prescribed rules (e.g., business rules), which may be stored in the database 122, for determining a configuration status of the observed WAP to thereby determine whether the WAP should be probed by an endpoint. Such rules applied to the observed WAP may include, but are not limited to, determining whether the WAP is misconfigured (i.e., “open”), whether the WAP is broadcasting the corporation's service set identifier (SSID), whether there are more than a prescribed threshold number of endpoints identifying the same WAP, whether a location of the identifying endpoints within a prescribed physical location, whether a strength of the WAP radio signal is greater than or less than a prescribed threshold, or some combination of one or more of these rules and/or other rules.

When it is determined that a given WAP should be probed by an endpoint, the central control entity 124 selects at least a subset (e.g., one or more) of the endpoints 102 through 104 to perform an active probe of the WAP. The selection of the endpoint(s) is a function of one or more of the prescribed rules (stored in the database 122). For example, the central control entity 124 may base a selection of an endpoint on a strength of the WAP radio signal received by endpoints (e.g., an endpoint with the strongest radio signal from the WAP may be selected). Alternatively, or in addition, an endpoint that most often has its wireless network card powered on may be selected, or some combination of these or other rules may be employed.

In one embodiment, in performing an active probe of the WAP, and the network corresponding to the WAP, the selected endpoint(s) may associate with the WAP (i.e., establish communication with the WAP) and then send one or more requests, such as, for example, a dynamic host configuration protocol (DHCP) ping, to network resources and observe the response from the WAP (e.g., IP address, default route, etc.). When any wireless client connects to a WAP, the WAP will respond with network information, which may include, for example, a range of valid network addresses, a client's assigned IP address within that range, and the default route (i.e., a default IP address to send all external packets.) This is the minimum information needed for the client to communicate on the network.

In another embodiment, the endpoint may probe the WAP by attempting to send a message to the central receiving entity 118 (located on the corporate intranet 116). This action confirms that the WAP is connected to the corporate intranet and in addition certain information can be obtained, such as, for example, the network path from the endpoint client to the central receiving entity 118, the IP address of the WAP, the routing between the endpoint and the central receiving entity, etc. At both the central control entity 124 and the central receiving entity 118, when it is determined that the WAP is misconfigured or should not be allowed on the intranet 116, an alert is generated (e.g., by the reporting and alert module 120). Although a connection between the central control entity 124 and the reporting and alert module 120 is not explicitly shown, it is to be appreciated that interaction between the two functional modules is contemplated. For example, the reporting and alert module 120 is operative in some embodiments as an administrative interface, and based on the observed data in the database, the reporting and alert module 120 may send directives to the central control entity 124 to have it alter its control of the endpoints.

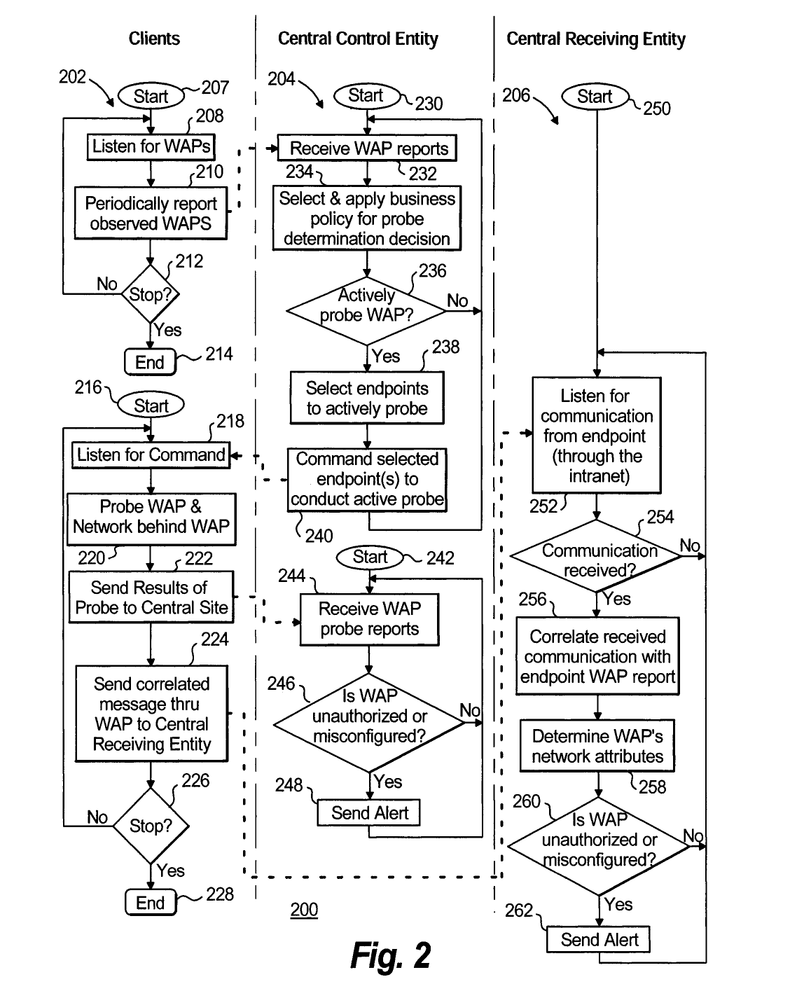

FIG. 2 is a flow diagram depicting at least a portion of an exemplary method 200 for identifying unauthorized or misconfigured WAPs in a system (e.g., communication network), according to an embodiment of the invention. As apparent from FIG. 2, the method 200 is divided into three functional components: a client component 202, at least a portion of which may be performed in a client module or endpoint, a central control component 204, at least a portion of which may be performed in the central control module (e.g., central control entity 124 in FIG. 1), and a central receiving component 206, at least a portion of which may be performed in the central receiving module (e.g., central receiving entity 118 in FIG. 1). Each of the functional components may be implemented using one or more agents. These components/agents may interact with one another (e.g., passing data therebetween) in performing the overall method 200 for identifying unauthorized or misconfigured WAPs.

The term “agent” as used herein is intended to be broadly defined as a software program that acts on behalf of a user or other program in a relationship of agency. Thus, an agent relates to a software abstraction, an idea, or a concept, similar to object-oriented programming terms such as methods, functions, and objects. The concept of an agent provides a convenient and powerful way to describe a complex software entity that is capable of acting with a certain degree of autonomy in order to accomplish tasks on behalf of its host. But unlike objects, which are defined in terms of methods and attributes, an agent is generally defined in terms of its behavior (e.g., an agent's behavior can be to take no action, to locate WAPs, and to probe specific WAPs).

With reference to FIG. 2, a first client methodology, which may be performed in at least one endpoint (e.g., endpoints 102 through 104 in FIG. 1) or other client module, is initiated in step 207, wherein the endpoint/client is operative to monitor (i.e., listen for) WAPs in step 208. The endpoint/client periodically transmits information (e.g., reports) corresponding to observed WAPs to the central control entity in step 210. In step 212, the endpoint/client checks to see whether or not the first client methodology should terminate in step 214. When it is determined that the first client methodology should not terminate, the endpoint/client is operative to continue listening for WAPs in step 208.

In a second client methodology initiated in step 216, which may be performed in at least one endpoint (e.g., endpoints 102 through 104 in FIG. 1) or other client module, the endpoint/client is operative in step 218 to listen for a command from a central control entity (e.g., central control entity 124 in FIG. 1) instructing the endpoint to begin active probing of an observed WAP. In step 220, the endpoint/client, upon receipt of the command, is operative to perform active probing of the observed WAP and the corresponding network associated with the observed WAP and to generate a WAP probe report comprising results of the active probing. In step 222, results of the active probing, as contained in the WAP probe report generated in step 220, are sent by the endpoint/client to the central control entity for further processing. In step 224, the endpoint/client is operative to transmit a correlated message through the observed WAP to a central receiving entity (e.g., central receiving entity 118 in FIG. 1). The correlated message sent by the endpoint preferably comprises the WAP probe report generated in step 220. The endpoint/client then determines in step 226 whether or not to terminate the second client methodology in step 228. When it is determined that the second client methodology should not terminate, the endpoint/client is operative to continue listening for a command from a central control entity in step 218.

In a first central control methodology initiated in step 230, which may be performed in a central control entity (e.g., central control entity 124 in FIG. 1) or other controller, the central control entity is operative in step 232 to receive information (e.g., reports) corresponding to observed WAPs transmitted by one or more endpoints/clients in step 210. In step 234, the central control entity is operative to select a given one of the received WAP reports and to apply prescribed rules (e.g., business policies) for determining whether or not to actively probe a given observed WAP in step 236. When it is determined in step 236 to actively probe the observed WAP, the central control entity selects one or more endpoints in step 238 to initiate active probing of the WAP. In step 240, a command is transmitted to each of the selected endpoints to conduct active probing of the WAP. The first central control methodology then proceeds to step 232 where the methodology is repeated. When it is determined in step 236 not to actively probe the observed WAP, the first central control methodology proceeds to step 232 where the methodology is repeated.

In a second central control methodology initiated in step 242, which may be performed in a central control entity (e.g., central control entity 124 in FIG. 1) or other controller, the central control entity is operative in step 244 to receive results of the active probing of the observed WAP transmitted by one or more endpoints in step 222. Based on information in the WAP probe report, the central control entity is operative in step 246 to determine whether or not the probed WAP is unauthorized or misconfigured. When the probed WAP is neither unauthorized nor misconfigured, the second central control methodology returns to step 244 to begin receiving additional results of the active probing of observed WAPs. Alternatively, when it is determined in step 246 that the probed WAP is unauthorized and/or misconfigured, the central control entity is operative to issue (e.g., transmit) an alert or other indication in step 248 communicating the status of the WAP as being unauthorized and/or misconfigured. The second central control methodology then returns to step 244 to begin receiving additional results of the active probing of observed WAPs.

In a central receiving methodology initiated in step 250, which may be performed in a central receiving entity (e.g., central receiving entity 118 in FIG. 1) or other interface/controller, the central receiving entity is operative in step 252 to monitor for communications from one or more endpoints, which may be received through an intranet (e.g., intranet 116 in FIG. 1) or other network. The communications being monitored in step 252 preferably comprise, for example, the WAP probe report generated by one or more endpoints in step 220. In step 254, the central receiving entity is operative to determine whether or not such communication from an endpoint has been received. When no communication has been received from an endpoint, the central receiving methodology returns to step 252, wherein the central receiving entity continues monitoring for communications from one or more endpoints. Steps 252 and 254 essentially form a repeating loop which is exited upon receipt of a communication from an endpoint.

When it is determined in step 254 that a communication has been received from an endpoint, the central receiving entity is operative in step 256 to correlate the received communication with an endpoint WAP report (e.g., WAP probe report) contained therein. In some embodiments, there are at least two related “probe” messages: a first message represented by the dotted line from step 222, referred to herein as a “probe report,” which comprises some of the results from actively probing the WAP, including a dynamic host configuration protocol (DHCP) address and a default route; and a second message represented by the dotted line from step 224, referred to herein as a “probe packet.” A difference between the two probe messages is that the “probe report” is sent on an endpoint's known connection to the intranet, while the “probe packet” is intended to travel on the WAP's connection to the intranet (if any).

With continued reference to FIG. 2, the central receiving entity is operative in step 258 to determine, as a function of information contained in the communication received from the endpoint, network attributes corresponding to the probed WAP. In step 260, the central receiving methodology determines whether or not the WAP is unauthorized or misconfigured. When the probed WAP is neither unauthorized nor misconfigured, the central receiving methodology returns to step 252 to continue monitoring for communications from the endpoints. Alternatively, when it is determined in step 260 that the WAP is unauthorized and/or misconfigured, the central receiving methodology issues (e.g., transmits) an alert or other indication in step 262 communicating the status of the WAP as being unauthorized and/or misconfigured. The central receiving methodology then returns to step 252 to continue monitoring for communications from the endpoints.

Techniques of the present invention can provide substantial beneficial technical effects. Embodiments of the invention may provide one or more of the following advantages, including, but not limited to: reducing the likelihood of a communication network being compromised by unauthorized users, thereby reducing the likelihood of data loss, data corruption or compromise; reducing the likelihood of virus and/or malware injection into the client infrastructure; ensuring compliance of WAPs to client or regulatory security configuration standards; and protecting employees of a corporate intranet, or other communication network, from connecting to unauthorized or rogue WAPs trying to impersonate a valid client WAP.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

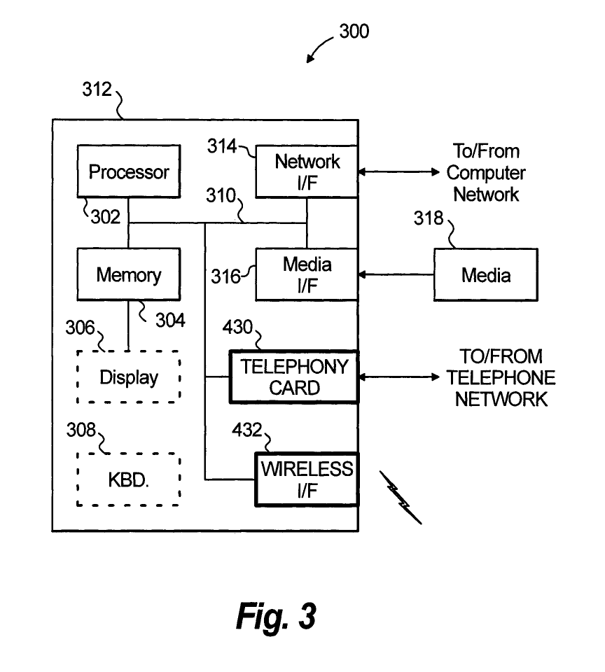

FIG. 3 is a block diagram depicting at least a portion of an exemplary system 300 operative to run software according to embodiments of the invention. System 300 may represent, for example, a general purpose computer or other computing device or systems of computing devices which, when programmed according to embodiments of the invention, become a specialized device operative to perform techniques of the invention. With reference to FIG. 3, such an implementation might employ, for example, a processor 302, a memory 304, and an input/output interface formed, for example, by a display 306 and a keyboard 308.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

Also included are a telephony card 430 coupled to the bus and interfacing with a telephone network, and a wireless interface 432 coupled to the bus and interfacing with a local and/or cellular wireless network.

Data processing unit 312 is representative of a device such as an endpoint, personal digital assistant, smart phone, or tablet; data processing unit 312 is also representative of a server in a communication network or the like. Some embodiments make use of multiple servers in a network. The multiple servers may be coupled over a local computer network (e.g. Ethernet) via network interfaces 314. Duties may be apportioned among servers; for example, some servers provide telephone access via cards 430; some servers carry out “number crunching” for speech recognition, and so on. Where techniques are carried out on a handheld device, some or all processing may be carried out externally. For example, signals can be sent wirelessly via wireless interface 432 to a powerful external server, possibly with some local pre-processing first.

As used herein, including the claims, a “server” includes a physical data processing system (for example, data processing unit 312 as shown in FIG. 3) running a server program. It will be understood that such a physical server may or may not include a display and keyboard. Further, not every server or device will necessarily have every feature depicted in FIG. 3.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 318 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language, FORTRAN, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 302. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for identifying at least one of unauthorized and misconfigured wireless access points (WAPs) in a communication network, the method comprising steps of:
an agent running on an endpoint in the communication network locating one or more WAPs in the communication network;
the agent reporting at least one located WAP to a central entity; and
the central entity performing steps of applying prescribed criteria to determine whether the at least one located WAP needs to be probed, and initiating active probing of the at least one located WAP when it is determined that the at least one located WAP needs to be probed to thereby determine whether the located WAP is at least one of unauthorized and misconfigured.

2. The method of claim 1, wherein at least one agent in the communication network is adapted for performing active probing of the located WAP.

3. The method of claim 1, further comprising selecting at least one endpoint in the communication network to perform the active probing, and instructing the endpoint to perform active probing of the located WAP.

4. The method of claim 3, wherein the selecting of an endpoint to perform the active probing is performed by the central entity as a function of one or more prescribed business rules.

5. The method of claim 1, further comprising generating an alert when the located WAP is determined to be at least one of unauthorized and misconfigured.

6. The method of claim 1, wherein the agent is adapted for locating one or more WAPs in the communication network during prescribed time intervals.

7. The method of claim 6, wherein the prescribed time intervals are periodic.

8. The method of claim 1, further comprising selecting a plurality of endpoints in the communication network for initiating active probing of a given located WAP.

9. The method of claim 1, wherein the step of active probing of the at least one located WAP comprises establishing communication with the WAP, transmitting at least one request to network resources, and observing a response from the WAP to the at least one request.
